(19) United States
(12) Patent Application Publication
(10) Pub. No.: US 2023/0166580 A1
(43) Pub. Date: Jun. 1, 2023

(54) HEATING UNIT AND VEHICLE HEATING DEVICE COMPRISING SAME

(71) Applicant: Hanon Systems, Daejeon (KR)

(72) Inventors: Dong Hoon OH, Daejeon (KR); Dae Bok KEON, Daejeon (KR); Tae Yong PARK, Daejeon (KR); Jeong Man LEE, Daejeon (KR)

(21) Appl. No.: 17/915,028

(22) PCT Filed: Apr. 12, 2021
(86) PCT No.: PCT/KR2021/004555

§ 371 Date: Sep. 27, 2022

(30) Foreign Application Priority Data
Apr. 14, 2020 (KR) 10-2020-0045324
Apr. 9, 2021 (KR) 10-2021-0046627

(51) Int. Cl. B60H 1/22

(52) U.S. Cl. CPC B60H 1/2226; B60H 1/2225; B60H 1/00671

(57) ABSTRACT

An embodiment provides a vehicle heating device for heating a vehicle interior through heat radiation or heat convection using a heating unit connected to an air-conditioning casing. Accordingly, the vehicle heating device may improve the performance, efficiency, and quality in heating the vehicle interior through at least any one of heat convection and heat radiation using the heating unit.

### TECHNICAL FIELD

An embodiment relates to a heating unit and a vehicle heating device including the same. Specifically, the embodiment relates to a vehicle heating device that improves the performance, efficiency, and quality in heating a vehicle interior through heat convection or heat radiation using a heating unit.

### BACKGROUND ART

A vehicle is equipped with an air-conditioning device for a vehicle that serves to adjust an air temperature or the like in a vehicle interior. The air-conditioning device may produce warm air to keep the interior of the vehicle warm in the winter season or produce cold air to keep the interior of the vehicle cool in the summer season.

The air-conditioning device may include an air-conditioning unit configured to supply air with an adjusted temperature to the vehicle interior, and a blower unit configured to supply air to the air-conditioning unit.

The air-conditioning unit may include: an air-conditioning casing having a plurality of discharge ducts; an evaporator disposed in the air-conditioning casing; a heater; and a door configured to adjust an air flow rate. Therefore, the air-conditioning unit may adjust a temperature of the air, which is to be supplied to the interior of the vehicle, by using the evaporator, the heater, and the door. In this case, the heater may be a positive temperature coefficient (PTC) heater using a PTC element.

Further, the blower unit may supply air into the air-conditioning unit by using a blower rotated by an actuator (not illustrated).

Meanwhile, the air-conditioning device may use an infrared lamp to perform local heating and air-conditioning.

As the invention related to the infrared lamp, there is Korean Patent Laid-Open No. 10-2018-0055961 (May 28, 2018) entitled ‘Infrared Ray Heater for Vehicle’.

FIG. 1 is a view illustrating an infrared heater for a vehicle in the related art.

Referring to FIG. 1, the infrared heater may locally heat an interior of the vehicle by using an infrared lamp 1400.

In this case, the infrared heater may include: heat radiating fins 1201 disposed in an air-conditioning duct 1200; reflective plates 1101 configured to reflect heat radiated from the infrared lamp 1400; and heat transfer parts 1103 configured to thermally connect the reflective plates 1101 and the heat radiating fins 1201. Further, the infrared heater may further include barrier films 1303 configured to cover an opening of the reflective plate 1101.

Because the infrared heater uses the infrared lamp 1400, the infrared heater needs to have the reflective plate 1101 and essentially have the heat transfer parts 1103 and the heat radiating fins 1201 to transfer heat to the air-conditioning duct 1200.

However, the configuration including the reflective plate 1101, the heat transfer parts 1103, and the heat radiating fins 1201 increases the size of the infrared heater. Therefore, because the infrared heater with the increased size needs to occupy a part of an interior space of the vehicle, the interior space is reduced, which limits a degree of design freedom of the vehicle.

In addition, because the infrared heater transfers radiant heat from the infrared lamp 1400 to the air-conditioning duct 1200 by using the reflective plate 1101, the heat transfer parts 1103, and the heat radiating fins 1201, thermal efficiency deteriorates in comparison with a case in which the radiant heat from the infrared lamp 1400 is directly used. That is, because the infrared heater indirectly uses the radiant heat from the infrared lamp 1400, thermal efficiency in comparison with a case in which the radiant heat from the infrared lamp 1400 is directly used.

Further, because the infrared heater indirectly uses the radiant heat from the infrared lamp 1400, there is a limitation in quickly increasing a temperature of air even though the PTC heater heats air, which is supplied by the blower unit, to a predetermined temperature and supplies the air to the interior of the vehicle. That is, because the infrared heater indirectly uses the radiant heat, there is a limitation in terms of the performance in quickly increasing a temperature in the vehicle interior.

### DISCLOSURE

### Technical Problem

An embodiment provides a heating unit, which heats an interior of an occupant compartment through at least any one of heat convection and heat radiation, and a vehicle heating device including the same.

An embodiment provides a heating unit, which allows air supplied from an air-conditioning device for a vehicle to directly perform heat exchange while passing through the heating unit, and a vehicle heating device including the same.

An embodiment provides a heating unit, which has a multilayer structure to define a plurality of heat exchange regions to improve heat exchange efficiency, and a vehicle heating device including the same.

An embodiment provides a heating unit, which prevents overheating by using a component such as a detector, and a vehicle heating device including the same.

An embodiment provides a heating unit, which is detachably and rotatably disposed, and a vehicle heating device including the same.

An embodiment provides a separate heating unit installed in a discharge duct of an air-conditioning device for a vehicle without a separate structure such as a housing.

Objectives to be solved by the present invention are not limited to the above-described objectives, and other objectives, which are not described above, will be clearly understood by those skilled in the art from the following description.

### Technical Solution

The above-mentioned objects are achieved by a vehicle heating device that heats an interior of an occupant compartment through at least any one of heat convection and heat radiation of a heating unit. In this case, a heating unit may have one side connected to an air-conditioning casing and the other side disposed toward an occupant in an occupant compartment. Further, the heat convection may be formed in the occupant compartment by heating air supplied from the air-conditioning casing and passing through the heating unit. Further, the heat radiation may radiate heat directly toward the occupant.

The heating unit may include: a frame; and a planar upper heating element and a planar lower heating element disposed on the frame and spaced apart from each other to define a heat exchange region, and heat radiated from the upper heating element and heat radiated from the lower heating element may exchange heat with air passing through the heating unit in the heat exchange region.

The heat exchange region may be provided in plural, and the plurality of heat exchange regions may include: a first heat exchange region formed at a front end of the upper heating element based on a flow direction of air; and a second heat exchange region formed between the upper heating element and the lower heating element.

Further, the second heat exchange region may be formed in the frame of the heating unit, and the upper heating element and the lower heating element may be disposed outside the frame.

In addition, air passing through ventilation holes of the upper heating element may exchange heat with radiant heat from the upper heating element and the lower heating element while being mixed with the radiant heat in the second heat exchange region before passing through ventilation holes of the lower heating element.

Meanwhile, the upper heating element and the lower heating element may each include: a planar body having a plurality of ventilation holes; heat generating parts mounted on the body; and first and second electrodes disposed on the body and configured to apply power to the heat generating parts.

In addition, the heat generating parts of the lower heating element may be disposed to overlap the ventilation holes of the upper heating element based on a flow direction of air.

In addition, the ventilation hole of the lower heating element may be disposed to overlap the ventilation hole of the upper heating element based on a flow direction of air.

In addition, the heat generating parts may be disposed adjacent to the ventilation holes or disposed to be spaced apart from the ventilation holes with the electrodes interposed therebetween.

In addition, the body of the upper heating element may include: a first surface disposed to face the lower heating element; and a second surface opposite to the first surface, and the heat generating parts of the upper heating element may be disposed on the second surface and face air supplied toward the heating unit.

Meanwhile, the heating unit may include: a frame; a planar heating element disposed on the frame and configured to generate heat; and a fixing member coupled to the frame and configured to fix the heating element to the frame, the heating element may include: a planar body having a plurality of ventilation holes; heat generating parts mounted on the body; and first and second electrodes disposed on the body and configured to apply power to the heat generating parts, and the body may be bent to define an upper heating element and a lower heating element disposed to be spaced apart from each other.

Further, the first electrodes may include: an upper first electrode electrically connected to the upper heating element; and a lower first electrode electrically connected to the lower heating element, and the control unit may selectively apply power to the upper first electrode and the lower first electrode.

In addition, the heating element may include: two active regions in which the heat generating parts are disposed; and an inactive region disposed between the two active regions, and the inactive region may be disposed to face one surface of the frame.

Meanwhile, the heating unit may include: a frame, a planar heating element disposed on the frame and configured to generate heat; and a detector disposed to be in contact with the heating element, the heating element may include: a planar body having a plurality of ventilation holes; heat generating parts mounted on the body; and first and second electrodes disposed on the body and configured to apply power to the heat generating parts, and the application of power to the heat generating part may be cut off when a line disposed on the detector is deformed.

The vehicle heating device may further include a housing having one side connected to a floor duct of the air-conditioning casing and the other side having an opening. In this case, the heating unit may be disposed in the opening, and the housing may be rotatably disposed at an end of the floor duct.

In addition, the vehicle heating device may further include a housing having one side connected to a floor duct of the air-conditioning casing and the other side having an opening. In this case, the housing may include: a duct part connected to the floor duct and configured to communicate with the floor duct; and a guide disposed in the opening, and the guide may guide air, which is discharged through a plurality of holes, to the heating unit.

Further, the guide may include: a body having a plurality of holes; and a guide protrusion protruding from the body, the plurality of holes may include first and second holes having different sizes, the second hole may be disposed to be closer to the air-conditioning casing than is the first hole, and the guide protrusion may guide air discharged through the first hole.

In addition, the housing may further include a heating part disposed on one surface of an inner portion of the duct part. In this case, the heating part may heat air flowing along an interior of the duct part.

The above-mentioned objects are achieved by a heating unit including: a frame; and a planar upper heating element and a planar lower heating element disposed on the frame and spaced apart from each other to define a heat exchange region, in which the upper heating element and the lower heating element each include: a planar body having a plurality of ventilation holes; heat generating parts mounted on the body; and first and second electrodes disposed on the body and configured to apply power to the heat generating parts, and in which heat radiated from the upper heating element and heat radiated from the lower heating element exchange heat with air passing through the heat exchange region in the heat exchange region.

In this case, the heat generating parts of the lower heating element may be disposed to overlap the ventilation holes of the upper heating element based on a flow direction of air.

### Advantageous Effects

The vehicle heating device according to the embodiment may improve the performance, efficiency, and quality in heating the vehicle interior through heat convection or heat radiation using the heating unit. Specifically, the vehicle heating device may heat the vehicle interior through the heat convection by heating the air supplied from the air-conditioning device for a vehicle and supplying the air to the vehicle interior. In addition, it is possible to quickly heat the occupant by implementing the direct heating through the heat radiation. In this case, the vehicle heating device may selectively control the heating made by the heat convection and the heating made by the heat radiation, thereby improving the heating quality.

In addition, the vehicle heating device may improve the heating performance, efficiency, and quality by providing various embodiments related to the arrangement structure of the heating unit.

In addition, the heating unit may implement the compact structure by using the planar flexible heat generating film, thereby improving a degree of design freedom of the vehicle heating device.

In addition, the vehicle heating device may improve the stability by preventing overheating of the heating unit.

Various useful advantages and effects of the embodiments are not limited to the above-described contents and will be more easily understood from descriptions of the specific embodiments.

### DESCRIPTION OF DRAWINGS

FIG. 1 is a view illustrating an infrared heater for a vehicle in the related art.

FIG. 2 is a view illustrating a vehicle heating device according to an embodiment that is connected to an air-conditioning device for a vehicle.

FIGS. 3 and 4 are views illustrating the vehicle heating device according to the embodiment that is connected to the air-conditioning device for a vehicle.

FIG. 5A is a view illustrating a state in which the vehicle heating device according to the embodiment heats an ankle side of an occupant.

FIG. 5B is a view illustrating a state in which the vehicle heating device according to the embodiment heats a shin side of an occupant.

FIG. 6 is a perspective view illustrating the vehicle heating device according to the embodiment.

FIG. 7 is a bottom perspective view illustrating the vehicle heating device according to the embodiment.

FIG. 8 is an exploded perspective view illustrating the vehicle heating device according to the embodiment.

FIG. 9 is an exploded perspective view illustrating a housing of the vehicle heating device according to the embodiment.

FIG. 10A is a view illustrating one embodiment of a guide.

FIG. 10B is a view illustrating a flow of air guided by the guide according to the embodiment.

FIG. 11A is a view illustrating another embodiment of the guide.

FIG. 11B is a view illustrating a flow of air guided by the guide according to another embodiment.

FIG. 12 is an exploded perspective view illustrating a heating unit of the vehicle heating device according to the embodiment.

FIG. 13 is a view illustrating a first embodiment of a heating element disposed in the heating unit of the vehicle heating device according to the embodiment.

FIG. 14 is a view illustrating a second embodiment of the heating element disposed in the heating unit of the vehicle heating device according to the embodiment.

FIG. 15 is a view illustrating a flow of air passing through the housing and the heating element of the vehicle heating device according to the embodiment.

FIG. 16 is a view illustrating an arrangement relationship between the heating element and a detector of the vehicle heating device according to the embodiment.

FIG. 17 is a view illustrating an arrangement of the heating element of the vehicle heating device according to the embodiment.

FIG. 18 is a view illustrating a flow of air passing through the housing and the heating element of the vehicle heating device according to the embodiment.

FIG. 19 is a view illustrating heat exchange performed by the heating element of the vehicle heating device according to the embodiment.

FIG. 20 is a view illustrating a third embodiment of the heating element disposed in the heating unit of the vehicle heating device according to the embodiment.

FIG. 21 is a view illustrating another embodiment of the heating element according to the third embodiment disposed in the heating unit of the vehicle heating device according to the embodiment.

FIG. 22 is a view illustrating a fourth embodiment of the heating element disposed in the heating unit of the vehicle heating device according to the embodiment.

FIG. 23 is a view illustrating an electrical connection relationship between the heating element and a control unit according to the fourth embodiment of the vehicle heating device according to the embodiment.

FIG. 24 is a view illustrating the vehicle heating device according to the embodiment that includes a heating part.

FIG. 25 is a view illustrating a maximum heating mode of the vehicle heating device according to the embodiment.

FIG. 26 is a view illustrating a mild heating mode of the vehicle heating device according to the embodiment.

FIG. 27 is a view illustrating a radiation mode of the vehicle heating device according to the embodiment.

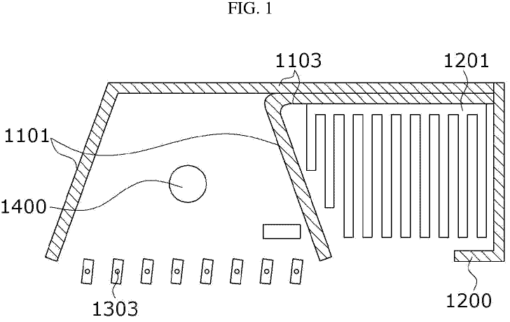

### MODES OF THE INVENTION

Hereinafter, exemplary embodiments of the present invention will be described in detail with reference the accompanying drawings.

However, the technical spirit of the present invention is not limited to some embodiments which will be described and may be embodied in a variety of different forms, and at least one or more components of the embodiments may be selectively combined, substituted, and used within the range of the technical spirit.

In addition, unless clearly and specifically defined otherwise by the context, all terms (including technical and scientific terms) used herein can be interpreted as having meanings customarily understood by those skilled in the art, and meanings of generally used terms, such as those defined in commonly used dictionaries, will be interpreted in consideration of contextual meanings of the related art.

In addition, the terms used in the embodiments of the present invention are considered in a descriptive sense only and not to limit the present invention.

In the present specification, unless clearly indicated otherwise by the context, singular forms include the plural forms thereof, and in a case in which “at least one (or one or more) among A, B, and C” is described, this may include at least one combination among all possible combinations of A, B, and C.

In addition, in descriptions of components of the present invention, terms such as “first,” “second,” “A,” “B,” “(a),” and “(b)” can be used.

The terms are only to distinguish one element from another element, and the essence, order, and the like of the elements are not limited by the terms.

In addition, it should be understood that, when an element is referred to as being “connected” or “coupled” to another element, such a description may include both a case in which the element is directly connected or coupled to another element, and a case in which the element is connected or coupled to another element with still another element disposed therebetween.

In addition, when any one element is described as being formed or disposed “on” or “under” another element, such a description includes both a case in which the two elements are formed or disposed in direct contact with each other and a case in which one or more other elements are interposed between the two elements. In addition, when one element is described as being formed “on or under” another element, such a description may include a case in which the one element is formed at an upper side or a lower side with respect to another element.

Hereinafter, in the detailed description of the example embodiments of the invention with reference to the accompanying drawings, components that are the same or correspond to each other will be denoted by the same reference numerals in all of the figures, and redundant descriptions will be omitted.

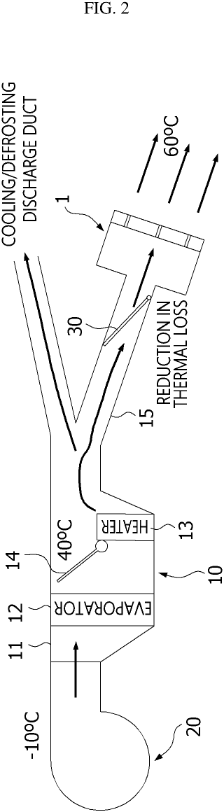

FIG. 2 is a view illustrating a vehicle heating device according to the embodiment that is connected to an air-conditioning device for a vehicle and may be a conceptual view illustrating a flow of air between a vehicle interior and an air-conditioning device for a vehicle.

Referring to FIG. 2, a vehicle heating device 1 according to the embodiment is connected to one side of an air-conditioning unit 10 configured to supply air to the vehicle interior, and the vehicle heating device may heat an interior of an occupant compartment through at least any one of heat convection and heat radiation. In this case, a blower unit 20 may supply air into the air-conditioning unit 10 by using a blower rotated by an actuator (not illustrated). Further, the air-conditioning unit 10 may include a cooling heat exchanger and a heating heat exchanger that are disposed therein. Therefore, a temperature of air passing through the air-conditioning unit 10 may be adjusted.

The vehicle heating device 1 may be connected to one side of an air-conditioning casing 11 of the air-conditioning unit 10. Specifically, the vehicle heating device 1 may be connected to and communicate with a floor duct 15 among a plurality of discharge ducts disposed at one side of the air-conditioning casing 11 and heat air flowing along the floor duct 15.

Therefore, even though a heater 13 disposed in the air-conditioning casing 11 heats the air to about 40 degrees, the vehicle heating device 1 connected to an end of the floor duct 15 compensates for a temperature of the air and heats the vehicle interior, which makes it possible to minimize a thermal loss through the floor duct 15. For example, in the related art in which the vehicle heating device 1 is not installed in the floor duct 15, the heater 13 disposed in the air-conditioning casing 11 heats air to a high temperature of 65 degrees or more and supply the heat to the interior of the vehicle, thereby heating the interior of the vehicle. In this case, the heater 13 may be a positive temperature coefficient (PTC) heater using a PTC element.

Therefore, the vehicle heating device 1 may implement the heat radiation directly toward an occupant while directly heating the air flowing through the heating unit by using the heating unit, thereby improving the performance and quality in heating the occupant that is an object to be heated.

In this case, the example has been described in which the vehicle heating device 1 performs the heat convection made by the blower unit 20 and the heating unit and the heat radiation made by the heating unit, but the present invention is not necessarily limited thereto. For example, the vehicle heating device 1 may use a control unit (not illustrated) to selectively implement only the heat convection made by the blower unit 10 and the heating unit or the heat radiation made by the heating unit. In this case, the control unit may be an electric control unit (ECU) that is an electronic control device of the vehicle.

In addition, doors 30 may be further disposed in the floor duct 15 and controlled by the control unit. Therefore, the doors 30 may adjust the amount of air flowing along the floor duct 15 or block the air.

In this case, to distinguish between a door 14 disposed in the air-conditioning casing 11 and a door 30 disposed in the floor duct 15, the door 14 disposed in the air-conditioning casing 11 may be referred to as a first door, and the door 30 disposed in the floor duct 15 may be referred to as a duct door or a second door. Further, the example has been described in which the door 30 is disposed in the floor duct 15, but the present invention is not necessarily limited thereto. For example, the door 30 may be disposed in a housing of the vehicle heating device 1.

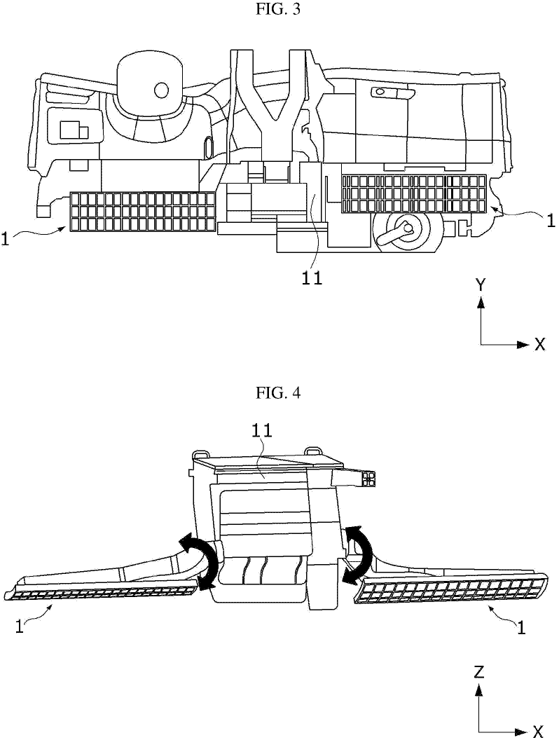

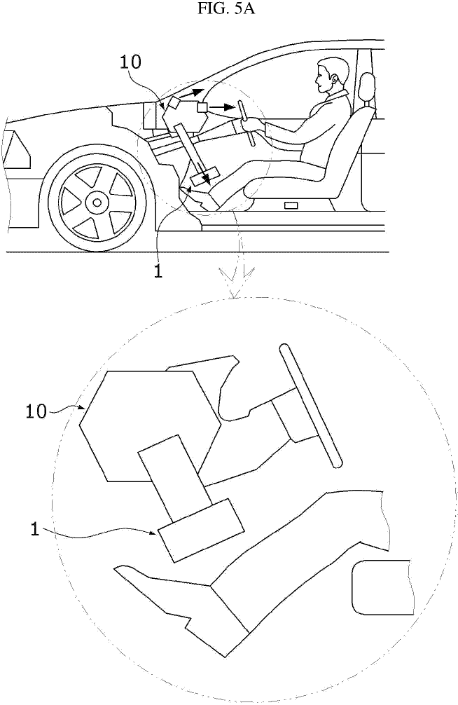

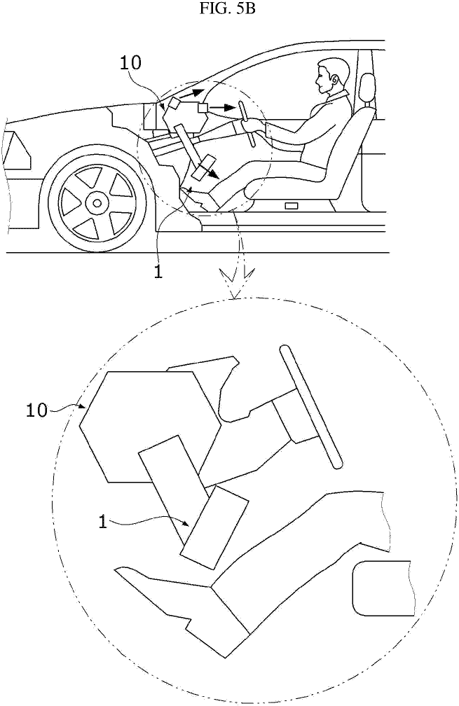

FIGS. 3 and 4 are views illustrating the vehicle heating device according to the embodiment that is connected to the air-conditioning device for a vehicle, FIG. 5A is a view illustrating a state in which the vehicle heating device according to the embodiment heats an ankle side of an occupant, and FIG. 5B is a view illustrating a state in which the vehicle heating device according to the embodiment heats a shin side of an occupant. In FIGS. 3 and 4, an X direction may indicate a vehicle width direction, a Y direction may indicate a forward/rearward direction of a vehicle body, and a Z direction may indicate an upward/downward direction or a vertical direction.

Referring to FIGS. 3 and 4, the vehicle heating devices 1 may be disposed at two opposite sides based on the air-conditioning casing 11. For example, at least two vehicle heating devices 1 may be disposed at the two opposite sides of the air-conditioning casing 11 based on the vehicle width direction for an occupant in a driver seat and an occupant in a front passenger seat. The vehicle heating device may be disposed adjacent to the driver seat or the front passenger seat at a predetermined interval from the occupant.

In addition, the vehicle heating device 1 may be detachably disposed in the floor duct 15 and thus easily maintained.

In addition, the vehicle heating device 1 may be rotatably disposed in the floor duct 15 and adjust a heating angle. Therefore, the vehicle heating device 1 may improve the performance and quality in heating the occupant.

As illustrated in FIG. 5A, the vehicle heating device 1 may rotate and heat the ankle side of the occupant. As illustrated in FIG. 5B, the vehicle heating device 1 may rotate and heat the shin side of the occupant.

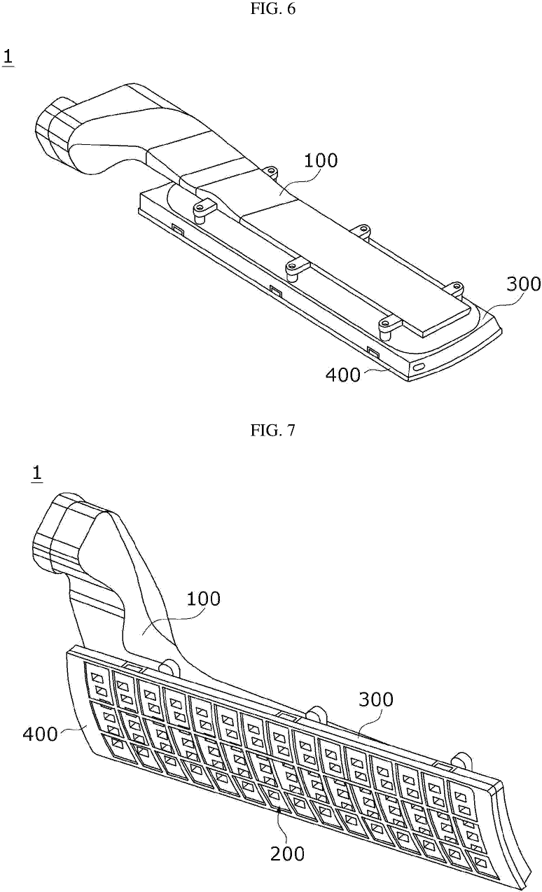

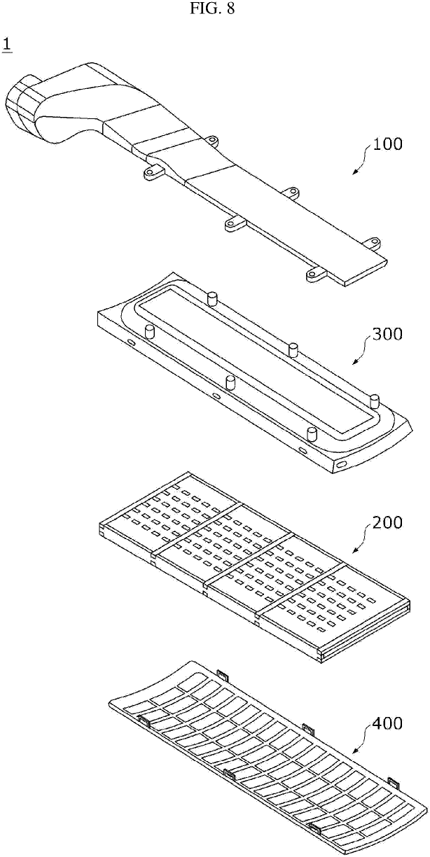

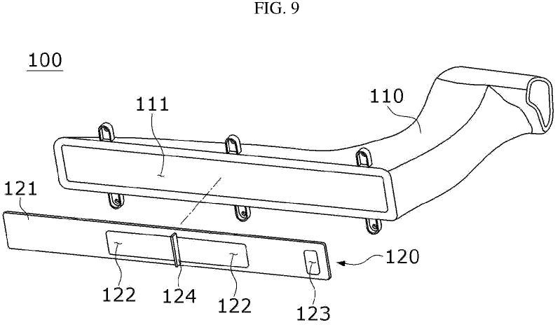

FIG. 6 is a perspective view illustrating the vehicle heating device according to the embodiment, FIG. 7 is a bottom perspective view illustrating the vehicle heating device according to the embodiment, and FIG. 8 is an exploded perspective view illustrating the vehicle heating device according to the embodiment.

Referring to FIGS. 6 to 8, the vehicle heating device 1 may include a housing 100 having one side disposed to communicate with the floor duct 15, and a heating unit 200 disposed in an opening of the housing 100. Further, the vehicle heating device 1 may include a support member 300 disposed between the housing 100 and the heating unit 200 and configured to support the heating unit 200. In addition, the vehicle heating device 1 may further include a cover 400 disposed at a lower side of the vehicle heating device, which is one side of the heating unit 200, to prevent the heating unit 200 from coming into contact with a human body or an object. In this case, the housing 100, the support member 300, and the cover 400 may define an external shape of the vehicle heating device 1.

The vehicle heating device 1 may be separately connected to the end of the floor duct 15 by means of a structure such as the housing 100. Therefore, the vehicle heating device 1 may implement the detaching and rotatable structure, which makes it possible to improve the quality in heating the occupant and makes it easy to perform the maintenance.

Alternatively, the vehicle heating device 1 may be implemented such that only the heating unit 200, which radiates heat, is installed at the end of the floor duct 15. Therefore, the vehicle heating device 1 may ensure the vehicle interior space by implementing the compact size.

The housing 100 may be connected to and communicate with the floor duct 15. In this case, one side of the housing 100 may be detachably and rotatably disposed in the floor duct 15. Therefore, the housing 100 may serve as a movement passage for air so that the air may flow from the floor duct 15 to the heating unit 200.

In this case, the example has been described in which the housing 100 is separately, detachably, and rotatably in the floor duct 15, but the present invention is not necessarily limited thereto. For example, the housing 100 may be provided as a part of the floor duct 15. That is, the housing 100 and the floor duct 15 may be integrated. When the housing and the floor duct are integrated, the attachment/detachment and rotation of the housing 100 may be restricted.

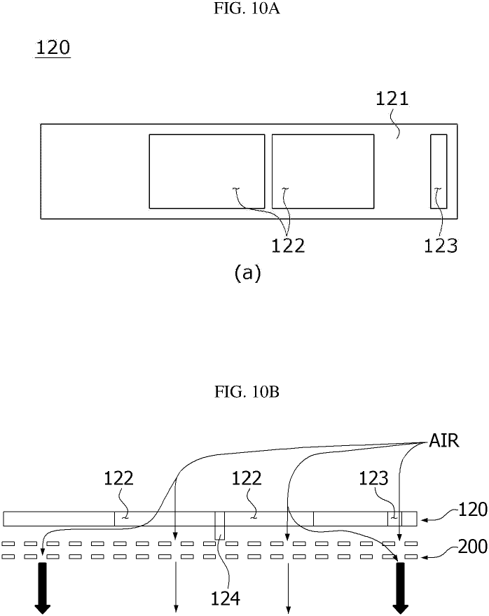

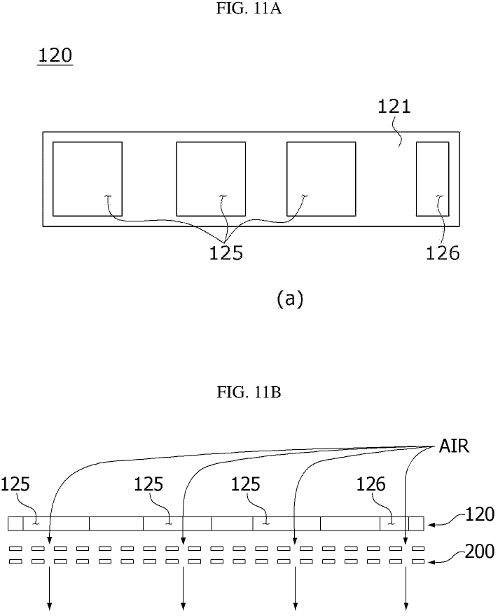

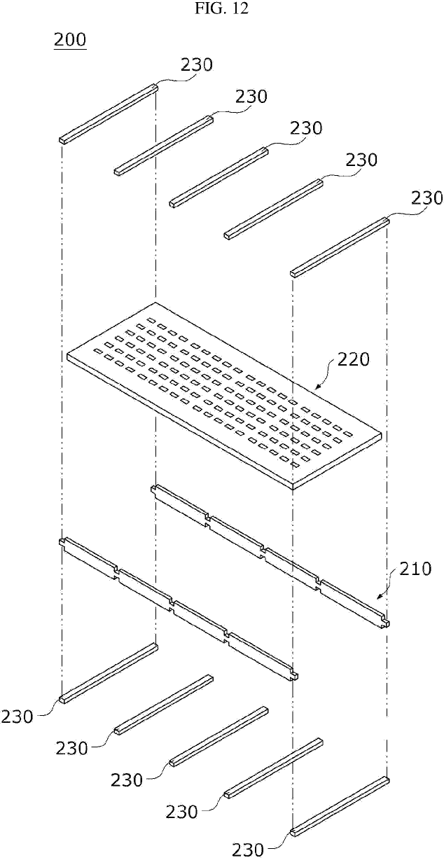

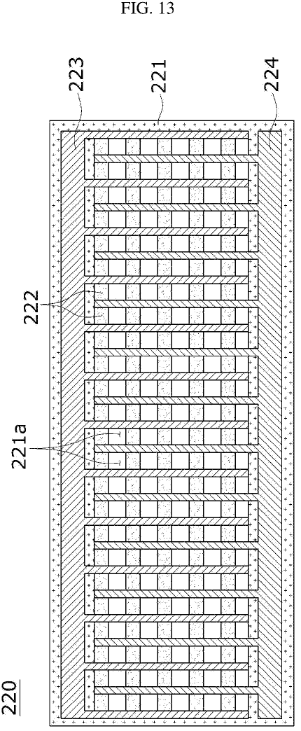

FIG. 9 is an exploded perspective view illustrating the housing of the vehicle heating device according to the embodiment. FIG. 10 is a view illustrating one embodiment of a guide disposed in the housing of the vehicle heating device according to the embodiment, in which FIG. 10A is a view illustrating one embodiment of the guide, and FIG. 10B is a view illustrating a flow of air guided by the guide according to the embodiment. FIG. 11 is a view illustrating another embodiment of the guide disposed in the housing of the vehicle heating device according to the embodiment, in which FIG. 11A is a view illustrating another embodiment of the guide, and FIG. 11B is a view illustrating a flow of air guided by the guide according to another embodiment. The arrows illustrated in FIGS. 10B and 11B may indicate the flows of air made by the vehicle heating device 1, and the thickness of the arrow may indicate the discharge amount of air.

Referring to FIG. 9, the housing 100 may include a duct part 110 connected to the floor duct 15 and configured to communicate with the floor duct 15, and a guide 120 configured to guide the air discharged through the duct part 110. In this case, the housing 100 may have various shapes made by injection molding a synthetic resin material such as plastic. Further, the housing 100 may be referred to as a first housing or an outer housing.

The duct part 110 may guide the air supplied through the floor duct 15. Further, one side of the duct part 110 may be disposed to communicate with the floor duct 15, and an opening 111 may be formed at the other side of the duct part so that the air may be discharged.

The guide 120 may be disposed in the opening 111. In this case, the guide 120 may be referred to as an air flow guide or a first guide.

Referring to FIGS. 9, 10A, and 10B, the guide 120 may include a guide body 121, and a plurality of holes formed through the guide body 121. Further, the guide 120 may further include a guide protrusion 124 configured to guide the air discharged through the hole.

The guide body 121 may be provided in the form of a plate and formed by injection molding a synthetic resin material such as plastic. As illustrated in FIGS. 9, 10A, and 10B, an example is described in which the guide body 121 is formed in a rectangular shape, but the present invention is not necessarily limited thereto.

The plurality of holes may have various shapes in consideration of the discharge amount and discharge position of the air guided by the duct part 110.

The guide protrusion 124 may protrude from the guide body 121 in a discharge direction of air. For example, the guide protrusion 124 may protrude toward the heating unit 200.

Referring to FIGS. 10A and 10B, the plurality of holes may include first holes 122 and a second hole 123. The first holes 122 and the second hole 123 may be formed in the guide body 121 and have different shapes and areas. Therefore, the air discharged through the first hole 122 and the air discharged through the second hole 123 may be different in discharge positions and discharge amounts.

For example, an area of the first hole 122 may be larger than an area of the second hole 123. The second hole 123 may be disposed to be closer to the air-conditioning casing 11 than is the first hole 122. As illustrated in FIG. 10B, the second hole 123 may be disposed to be farther from the guide protrusion 124 than is the first hole 122.

Further, the two first holes 122 may be disposed adjacent to each other. In this case, the two first holes 122 may be disposed symmetrically with respect to the guide protrusion 124. That is, the guide protrusion 124 may be disposed between the two first holes 122. Therefore, the guide protrusion 124 may divide and guide the air discharged through the two first holes 122.

Therefore, the housing 100 may improve the air-conditioning quality for the occupant through the first and second holes 122 and 123 having different areas. As illustrated in FIG. 10B, the first holes 122, the second hole 123, and the guide protrusion 124 may guide a large amount of heated air toward a foot side that feels cold air more than the other body portions. Therefore, the arrangement and shapes of the holes of the vehicle heating device 1 may improve heating quality such as thermal sensation of the occupant among the air-conditioning qualities.

Referring to FIGS. 11A and 11B, the plurality of holes may include third and fourth holes 125 and 126 having different areas. The third holes 125 and the fourth hole 126 may have different shapes and areas. Therefore, the air discharged through the third hole 125 and the air discharged through the fourth hole 126 may be different in discharge positions and discharge amounts. However, the arrangement of the third holes 125 and the fourth hole 126 may allow the housing 100 to uniformly discharge the air.

For example, an area of the third hole 125 may be larger than an area of the fourth hole 126. The fourth hole 126 may be disposed to be closer to the air-conditioning casing 11 than is the third hole 125. In this case, the plurality of third holes 125 may be disposed in the guide body 121 and spaced apart from one another. In this case, the number of third holes 125 may be larger than the number of first holes 122. The third hole 125 may have a smaller area than the first hole 122. In addition, the fourth hole 126 may have a larger area than the second hole 123.

Therefore, a uniform flow of air may be implemented by the housing 100 in which the shapes and areas of the third and fourth holes 125 and 126 are defined in consideration of resistance of air. As illustrated in FIG. 11B, a uniform flow of air may be implemented by the guide 120 having the third and fourth holes 125 and 126.

The heating unit 200 may heat the air, which is guided by the housing 100 by using a heating element that generates heat by using electricity. For example, the heating element may be a PTC element, but the present invention is not necessarily limited thereto.

The heating unit 200 may raise a temperature of the air heated by the heater 13, thereby minimizing a thermal loss caused by the floor duct 15 having a predetermined length. For example, the heater 13 heats the air to about 40 degrees lower than a heating temperature at which air is heated in the related art. Therefore, it is possible to minimize a thermal loss caused by the floor duct 15.

In addition, the heating unit 200 may directly heat the occupant by using radiant energy of the heat from the heating element.

FIG. 12 is an exploded perspective view illustrating the heating unit of the vehicle heating device according to the embodiment.

Referring to FIG. 12, the heating unit 200 may include frames 210, a planar heating element 220 disposed on the frames 210 and configured to generate heat, and fixing members 230 coupled to the frames 210 and configured to fix the heating element 220 to the frames 210.

The frames 210 may be formed in two bar shapes disposed to be spaced apart from each other and formed by injection molding a synthetic resin material such as plastic. In this case, the example has been described in which the frames 210 are provided in the two bar shapes, but the present invention is not necessarily limited thereto. For example, the frame 210 may be formed in a quadrangular shape such as a window frame.

The heating element 220 may be formed in a thin planar shape such as paper. Therefore, the heating element 220 may have flexibility and be referred to as a heat generating film.

Therefore, the heating element 220 may have a two-layer structure by bending at least one region. Therefore, a plurality of heat generating parts 222 may be disposed in a predetermined space of the heating element 220 having the two-layer structure, which makes it possible to improve the heat generating performance of the heating element 220. In this case, the heat generating parts 222 may be disposed vertically to correspond to a flow of air. For example, the heat generating parts 222 may be disposed in a flow direction of the air or disposed to face a flow of air.

The fixing members 230 may fix the heating element 220 to the frames 210.

As illustrated in FIG. 12, the heating element 220 may be fixed to the frames 210 by using the bar-type fixing members 230 coupled to upper and lower portions of the frames 210, but the present invention is not necessarily limited thereto. For example, the heating element 220 may be fixed to the frames 210 by using the fixing members 230 such as a bonding agent.

FIG. 13 is a view illustrating a first embodiment of the heating element disposed in the heating unit of the vehicle heating device according to the embodiment,

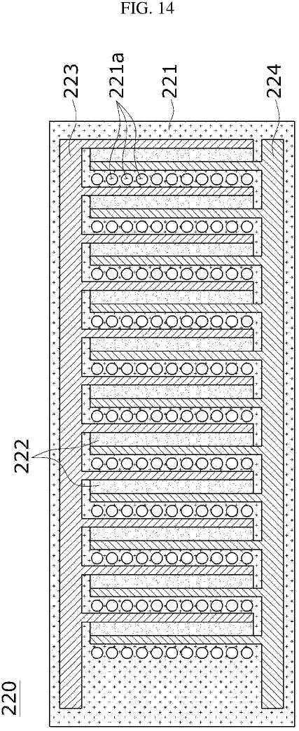

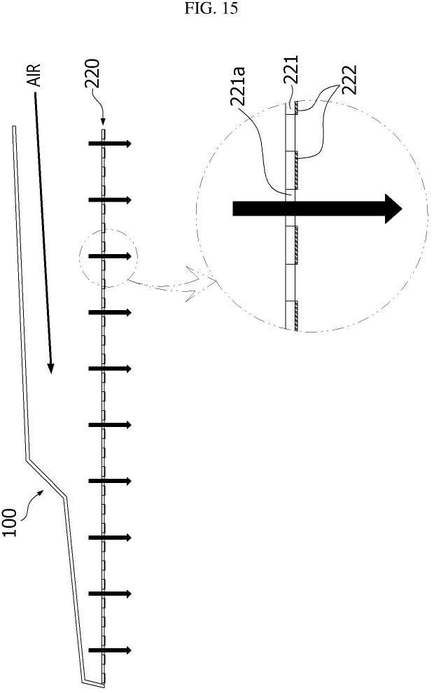

FIG. 14 is a view illustrating a second embodiment of the heating element disposed in the heating unit of the vehicle heating device according to the embodiment, and FIG. 15 is a view illustrating a flow of air passing through the housing and the heating element of the vehicle heating device according to the embodiment. In this case, the heating element according to the first embodiment illustrated in FIG. 13 may be referred to as a first heating element, and the heating element according to the second embodiment illustrated in FIG. 14 may be referred to as a second heating element.

Referring to FIGS. 13 and 14, the heating element 220 may include: a planar body 221 having a plurality of ventilation holes 221a; the heat generating parts 222 mounted on the body 221; and first and second electrodes 223 and 224 disposed on the body 221 and configured to apply power to the heat generating parts 222.

The body 221 may be formed in a planar shape. For example, the body 221 may be formed in a film shape.

Further, the body 221 may include the plurality of ventilation holes 221a formed through the body. Therefore, the air supplied into the housing 100 may be discharged by being guided by the ventilation holes 221a. In this case, the ventilation hole 221a may have various shapes in consideration of the structure of the frame 210 and the air-conditioning quality and be referred to as a body ventilation hole. Further, the body 221 may be referred to as a first body or a heating element body.

The heat generating parts 222 may radiate heat by using the power applied through the first and second electrodes 223 and 224. Further, the heat generating part 222 may be formed in a planar shape. In this case, the power may be controlled by the control unit.

In addition, the heat generating part 222 may be formed on the body 221 by printing using carbon-based ink having resistance. Alternatively, the heat generating part 222 may be formed on the body 221 by forming a planar heat generating pattern on a thin film material made of metal by etching. Alternatively, the heat generating part 222 may be formed by arranging a heat generating element such as a PTC element on the body 221. Therefore, the heat generating part 222 may be referred to as a heat generating pattern or a heat generating element.

In addition, the heat generating parts 222 may be disposed adjacent to the ventilation holes 221a. In this case, the configuration in which the heat generating parts are adjacent to the ventilation holes may mean that the heat generating parts are in contact with the ventilation holes or spaced apart from the ventilation holes at predetermined intervals.

As illustrated in FIG. 13, the ventilation holes 221a may be disposed between the heat generating parts 222. In this case, the ventilation holes 221a and the heat generating part 222 may be disposed between the first and second electrodes 223 and 224. Specifically, the ventilation holes 221a and the heat generating parts 222 may be alternately disposed in a first direction between the first and second electrodes 223 and 224.

Alternatively, as illustrated in FIG. 14, the ventilation holes 221a and the heat generating parts 222 may be disposed to be spaced apart from one another at predetermined intervals with the electrodes 223 and 224 interposed therebetween. For example, the first electrode 223 or the second electrode 224 may be disposed between the ventilation holes 221a and the heat generating parts 222 based on a second direction. In this case, the first direction and the second direction may be defined as directions perpendicular to each other in a plan view. In this case, the second direction may be a vehicle width direction.

The first and second electrodes 223 and 224 may apply power to the heat generating parts 222. In this case, the first electrode 223 may be a (+) electrode, and the second electrode 224 may be a (-) electrode.

Further, the first and second electrodes 223 and 224 may be electrically connected to one side and the other side of the heat generating part 222.

Referring to FIGS. 13 and 14, the heating element 220 may implement various shapes by the flexible structure of the body 221 and the sizes, shapes, and arrangement positions of the ventilation holes 221a, the heat generating parts 222, and the electrodes 223 and 224. Therefore, a degree of design freedom of the heating element 220 may be improved.

Referring to FIG. 15, the vehicle heating device 1 may heat the vehicle interior through the heat convection by heating the air, which flows into the housing 100 through the heating element 220 of the heating unit 200 and then passes through the heating unit 200, and discharging the air.

In addition, the vehicle heating device 1 may directly heat the occupant through the radiant heat generated by the heating element 220 of the heating unit 200.

Meanwhile, the heating unit 200 may include a detector 240 configured to detect overheating of the heating element 220. In this case, the detector 240 may be coupled to the heating element 220 in a laminated shape. In this case, the detector 240 may be referred to as an overheating sensing part.

The detector 240 may detect overheating of a local part of the heating element 220 or the entire heating element 220.

The detector 240 detects the abnormality of the heating element 220 heated to a preset temperature or higher. Therefore, the vehicle heating device 1 may cut off the application of power to the heating element 220. For example, the control unit may detect the abnormality of the heating element 220 by using the detector 240 and cut off the application of power to the heating element 220, thereby preventing overheating of the heating element 220. For example, the detector 240 may detect a change in resistance according to a temperature of the heating element 220. Based on the change in resistance, the control unit may prevent overheating of the heating element 220 by cutting off the application of power to the heating element 220.

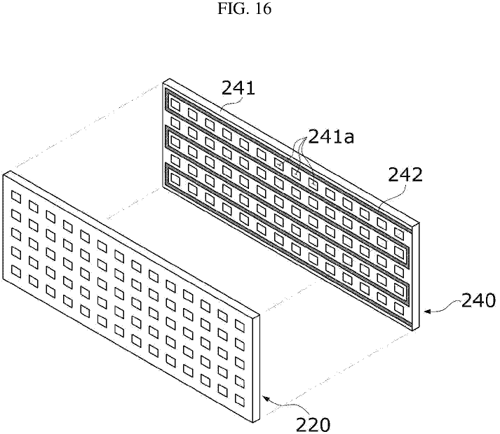

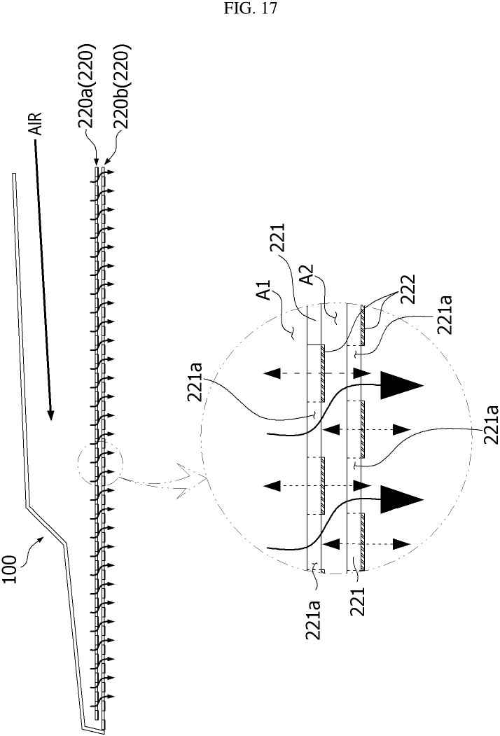

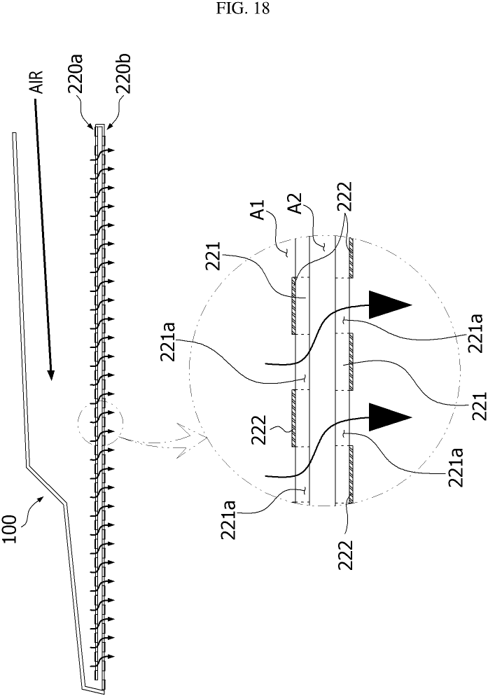

FIG. 16 is a view illustrating an arrangement relationship between the heating element and the detector of the vehicle heating device according to the embodiment.

Referring to FIG. 16, the detector 240 may include a body 241 and lines 242 disposed on the body 241. In this case, the body 241 may be referred to as a second body or a detector body.

The body 241 may be formed in a planar shape and include a plurality of ventilation holes 241a formed through the body 241. Further, the ventilation holes 241 a of the detector 240 may be disposed to face the ventilation holes 221a of the heating element 220. In this case, the body 241 may be an FPCB. Further, the ventilation hole 241a of the detector 240 may be referred to as a third ventilation hole or a detector ventilation hole and formed in a shape corresponding to the ventilation hole 221a of the heating element 220.

Further, the body 241 of the detector 240 may be disposed to be in contact with one surface of the body 221 of the heating element 220.

The line 242 may be disposed on one surface of the body 241. Further, the line 242 may be electrically connected to the control unit. In this case, because the line 242 may be disposed on the body 241 by printing, the line may be referred to as a printed layer.

A resistance value of the line 242 may be changed by the heat generated by the heating element 220. Therefore, the control unit may protect the heating element 220 by cutting off the application of power to the heating element 220 based on a difference between the resistance values.

For example, the heat generated by the heating element 220 may change the thickness, width, and length of the line 242 or disconnect the line 242. Therefore, the control unit may measure the resistance values before and after the line 242 is deformed. When the difference between the resistance values exceeds a preset value or deviates from the preset value, the control unit may protect the heating element 220 by cutting off the application of power to the heating element 220.

As illustrated in FIG. 16, the line 242 may be disposed as a loop-type line, and the arrangement structure of the loop-type line 242 makes it very easy to perform numerical detection of the resistance value.

In this case, the line 242 may be made of a metallic material having a small resistance value in consideration of sensitivity. The metallic material may be at least any one of metal among aluminum (Al), copper (Cu), silver (Ag), chromium (Cr), molybdenum (Mo), aluminum neodymium (AINd), molybdenum titanium (MoTi), and an alloy containing at least any one of the metallic materials. Further, the line 242 may be referred to as a strain gauge line.

Meanwhile, the vehicle heating device 1 may further improve the heating performance and quality by implementing various arrangement structures such as a structure in which the plurality of heating elements 220 is disposed to be spaced apart from one another in one direction.

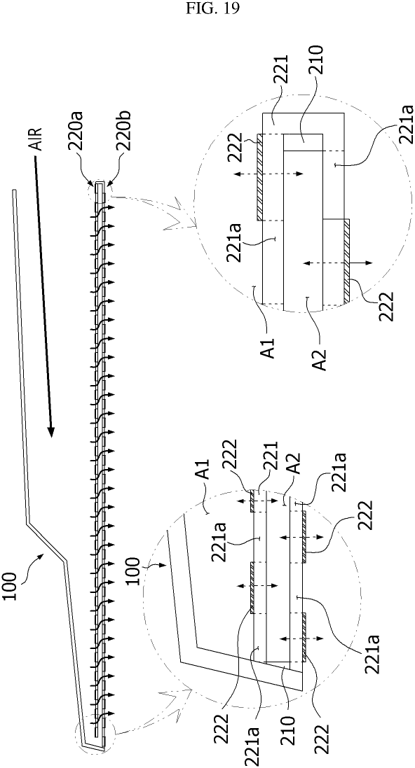

FIG. 17 is a view illustrating an arrangement of the heating element of the vehicle heating device according to the embodiment. The solid arrows illustrated in FIG. 17 may indicate flows of air, and the dotted arrows may indicate the heat radiated from the heating element.

Referring to FIGS. 12 and 17, the vehicle heating device 1 may include the housing 100, and the heating unit 200 disposed in the opening of the housing 100.

Further, the heating unit 200 of the vehicle heating device 1 may include: the frames 210; the at least two heating elements 220 disposed on the frame 210 so as to be spaced apart from one another in one direction to define the plurality of heat exchange regions; and the fixing members 230 coupled to the frames 210 and configured to prevent the heating elements 220 from separating from the frames 210. In this case, the at least two heating element 220 may be installed on the frames 210 and spaced apart from one another at predetermined intervals, thereby defining the exchange regions in which the heat radiated from the heating element 220 exchanges heat with the air.

In this case, the planar heating elements 220 illustrated in FIGS. 13 and 14 may be spaced apart from each other in the flow direction of air or the upward/downward direction and disposed in two layers, and the heating elements 220 may include upper heating element 220a and a lower heating element 220b defined based on arrangement positions. Therefore, the heat radiated from the upper heating element 220a and the heat radiated from the lower heating element 220b may exchange heat with the air passing through the heating unit 200 in the heat exchange region.

Referring to FIG. 17, based on the flow direction of air formed in the vehicle heating device 1, the heat exchange regions may include a first heat exchange region A1 formed at a front end of the upper heating element 220a, and a second heat exchange region A2 formed between the upper heating element 220a and the lower heating element 220b.

The first heat exchange region A1 may be a region in which the radiant heat radiated from the heat generating part 222 of the upper heating element 220a exchanges heat with the air flowing along the duct part 110 of the housing 100. Therefore, the first heat exchange region A1 may be formed in the duct part 110 and referred to as a preheating region.

The second heat exchange region A2 may be formed between the upper heating element 220a and the lower heating element 220b based on the flow direction of air and formed in the frames 210. In this case, the upper heating element 220a and the lower heating element 220b may be disposed outside the frame 210. Therefore, the air flowing between the upper heating element 220a and the lower heating element 220b may exchange heat with the radiant heat radiated from the heat generating parts 222 of the upper heating element 220a and the radiant heat radiated from the heat generating parts 222 of the lower heating element 220b. Specifically, the air having passed through the ventilation holes 221a of the upper heating element 220a may exchange heat with the radiant heat from the upper heating element 220a and the lower heating element 220b while being mixed with the radiant heat in the second heat exchange region A2 before passing through the ventilation holes 221a of the lower heating element 220b.

In addition, the ventilation holes 221a of the upper heating element 220a and the ventilation holes 221a of the lower heating element 220b are disposed in a staggered manner based on the flow direction of air, thereby improving the heating performance. For example, the ventilation holes 221a of the upper heating element 220a and the heat generating parts 222 of the lower heating element 220b are disposed to overlap one another in one direction (the flow direction of air or the upward/downward direction), such that the air having passed through the ventilation holes 221a of the upper heating element 220a may flow along the heat generating parts 222 of the lower heating element 220b, thereby further increasing the time for which the air stays in the second heat exchange region A2.

In addition, the heat generating parts 222 of the upper heating element 220a may be disposed to overlap the ventilation holes 221a of the lower heating element 220b in one direction, thereby improving the heat radiation performance. Therefore, it is possible to improve the heating efficiency and performance of the vehicle heating device 1.

Meanwhile, the ventilation hole 221a of the upper heating element 220a and the ventilation hole 221a of the lower heating element 220b may have different shapes, thereby further increasing the time for which the air stays in the second heat exchange region A2. For example, a staying part (not illustrated) such as a protrusion may be formed in the ventilation hole 221a of the lower heating element 220b and induce a turbulent flow, thereby further increasing the time for which the air stays in the second heat exchange region A2.

Alternatively, the heat generating parts 222 of the upper heating element 220a and the ventilation holes 221a of the lower heating element 220b may be disposed to overlap one another in one direction (the flow direction of air or the upward/downward direction).

Meanwhile, the upper heating element 220a and the lower heating element 220b may be controlled by the control unit. For example, the control unit may adjust the heating performance by controlling the power to be applied to the upper heating element 220a and the lower heating element 220b.

In addition, the upper heating element 220a and the lower heating element 220b may each be formed by bending one heating element.

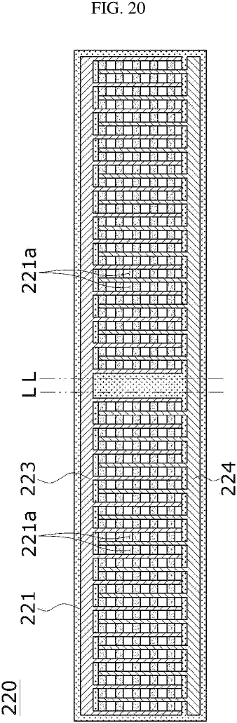

FIG. 18 is a view illustrating a flow of air passing through the housing and the heating element of the vehicle heating device according to the embodiment, FIG. 19 is a view illustrating heat exchange performed by the heating element of the vehicle heating device according to the embodiment, and FIG. 20 is a view illustrating a heating element according to a third embodiment that is disposed in the heating unit of the vehicle heating device according to the embodiment. In this case, the solid arrows illustrated in FIG. 18 may indicate flows of air. Further, the dotted arrows illustrated in FIG. 19 may indicate the heat radiated from the heating element. Further, a line L illustrated in FIG. 20 may mean a folding line.

The heating element illustrated in FIGS. 18 and 19 differs from the heating element illustrated in FIG. 17 in terms of arrangement positions of the heat generating parts 222 of the upper heating element 220a. For example, there is a difference in that the heat generating part 222 of the upper heating element 220a illustrated in FIGS. 18 and 19 is directed toward the first heat exchange region A1 and the heat generating part 222 of the upper heating element 220a illustrated in FIG. 17 is directed toward the second heat exchange region A2. That is, as illustrated in FIGS. 18 and 19, the body 221 of the upper heating element 220a may include a first surface disposed to face the lower heating element 220b, and a second surface opposite to the first surface. The heat generating parts 222 of the upper heating element 220a may be disposed on the second surface and face the air supplied to the heating unit 200.

Therefore, the heat generating parts 222 of the upper heating element 220a illustrated in FIGS. 18 and 19 may be defined by considering the heat exchange in the first heat exchange region A1 as important and provide the different heating quality from the heat generating parts 222 of the upper heating element 220a illustrated in FIG. 17.

Referring to FIGS. 18 and 19, based on the flow direction of air formed in the vehicle heating device 1, the heat exchange regions may include the first heat exchange region A1 formed at the front end of the upper heating element 220a, and the second heat exchange region A2 formed between the upper heating element 220a and the lower heating element 220b.

Further, the ventilation holes 221a of the upper heating element 220a and the heat generating parts 222 of the lower heating element 220b may be disposed to overlap one another in one direction (the flow direction of air or the upward/downward direction). Further, the heat generating parts 222 of the upper heating element 220a may be disposed to overlap the ventilation holes 221a of the lower heating element 220b in one direction, thereby improving the heat radiation performance. Therefore, it is possible to improve the heating efficiency and performance of the vehicle heating device 1.

In addition, the ventilation hole 221a of the upper heating element 220a and the ventilation hole 221a of the lower heating element 220b may have different shapes, thereby further increasing the time for which the air stays in the second heat exchange region A2.

Meanwhile, the heat generating parts 222 of the upper heating element 220a and the ventilation holes 221a of the lower heating element 220b may be disposed to overlap one another in one direction (the flow direction of air or the upward/downward direction).

Referring to FIGS. 18 to 20, in the heating element according to the third embodiment, the upper heating element 220a and the lower heating element 220b may be formed by bending a part of the line L of one heating element 220. In this case, the heating element according to the third embodiment may be referred to as a third heating element.

For example, the plurality of ventilation holes 221a is formed in the body 221 of one heating element 220 by blanking, the plurality of heat generating parts 222 is disposed, and then a bending region in which the ventilation hole 221a and the heat generating part 222 are not disposed is bent, such that it is possible to implement the upper heating element 220a and the lower heating element 220b illustrated in FIGS. 18 and 19. In this case, the region of the third heating element in which the ventilation hole 221a and the heat generating part 222 are disposed may be referred to as an active region, and the bending region may be referred to as an inactive region distinguishable from the active region. Therefore, the heating element 220 may include: two active regions in which the heat generating parts are disposed; and an inactive region disposed between the two active regions. The inactive region may be disposed to face one surface of the frame 210. Specifically, the inactive region may be in contact with one surface of the frame 210 through the fixing member 230 such as a bonding agent.

Therefore, as illustrated in FIGS. 18 and 19, the heat generating parts 222 disposed on the upper heating element 220a may be disposed toward an inner surface of an upper side of the duct part 110 and heat the air flowing through the duct part 110. In addition, the heat generating parts 222 disposed on the lower heating element 220b may be disposed at a lower side of the body 221 and directly heat the occupant.

In this case, as illustrated in FIG. 20, the third heating element may include the single first electrode 223 and the single second electrode 224 disposed on the body 221.

Meanwhile, as illustrated in FIGS. 18 and 19, the example has been described in which the heat generating parts 222 of the upper heating element 220a and the heat generating parts 222 of the lower heating element 220b, which are formed by using the single body 221, are disposed in different directions, but the present invention is not necessarily limited thereto. For example, the heat generating parts 222 are disposed on a part of one surface of the body 221 and a part of the other surface of the body 221 and then the body 221 is bent, such that the heat generating parts 222 of the upper heating element 220a and the heat generating parts 222 of the lower heating element 220b may be disposed to be directed in the same direction.

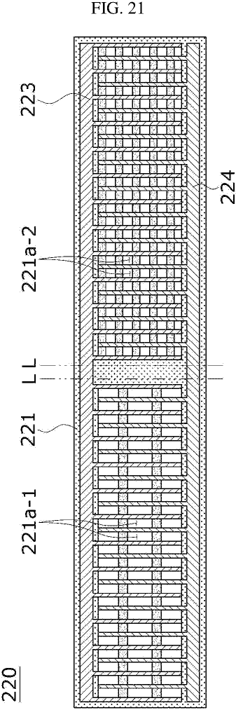

FIG. 21 is a view illustrating another embodiment of the heating element according to the third embodiment disposed in the heating unit of the vehicle heating device according to the embodiment.

As illustrated in FIG. 21, the body 221 may have a plurality of first ventilation holes 221a-1 and a plurality of second ventilation holes 221a-2. In this case, the first ventilation hole 221a-1 and the second ventilation hole 221a-2 are different in shapes and sizes. In this case, the first ventilation holes 221a-1 may be disposed on any one of the upper heating element 220a and the lower heating element 220b, and the second ventilation holes 221a-2 may be disposed on the other of the upper heating element 220a and the lower heating element 220b.

Therefore, the heat generating parts 222 illustrated in FIG. 21 and the heat generating parts 222 illustrated in FIG. 20 may be differently disposed, which makes it possible to implement various heat generating performance of the heating element 220.

Meanwhile, because the single first electrode 223 and the single second electrode 224 are disposed on the single body 221 in the third heating element, it is difficult to separately control the upper heating element 220a and the lower heating element 220b.

Therefore, any one of the first and second electrodes 223 and 224 may be provided as two electrodes separated from each other, and the separated two electrodes may be respectively disposed on the upper heating element 220a and the lower heating element 220b, thereby improving heating quality and efficiency.

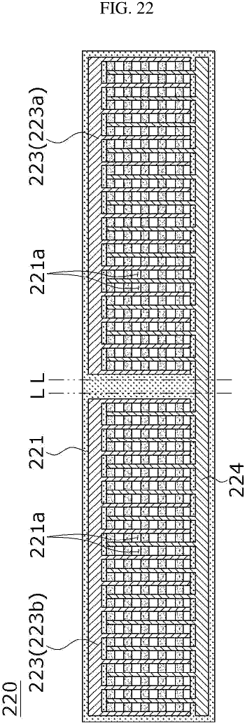

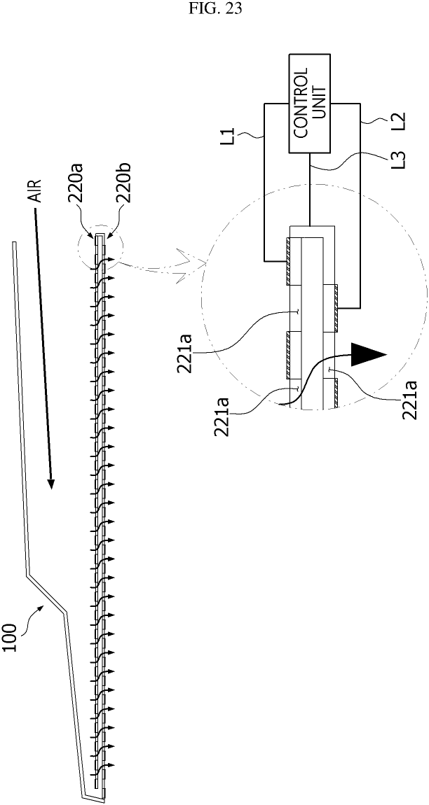

FIG. 22 is a view illustrating a fourth embodiment of the heating element disposed in the heating unit of the vehicle heating device according to the embodiment, and FIG. 23 is a view illustrating an electrical connection relationship between the heating element and the control unit according to the fourth embodiment of the vehicle heating device according to the embodiment. In this case, the line L illustrated in FIG. 22 may mean a folding line.

In the heating element according to the fourth embodiment, the upper heating element 220a and the lower heating element 220b may be formed by bending a part of the line L of one heating element 220. In this case, the heating element according to the fourth embodiment may be referred to as a fourth heating element.

The heating element according to the fourth embodiment differs from the heating element according to the third embodiment in that the heating element according to the fourth embodiment has two first electrodes 223.

Referring to FIG. 22, the heating element according to the fourth embodiment may include: the planar body 221 having the plurality of ventilation holes 221a; the heat generating parts 222 mounted on the body 221; and two first electrodes 223 and a single second electrode 224 disposed on the body 221 to apply power to the heat generating parts 222. In this case, the first electrodes 223 may include an upper first electrode 223a and a lower first electrode 223b.

Referring to FIGS. 22 and 23, the upper first electrode 223a and the lower first electrode 223b may be electrically connected to the control unit. In this case, the second electrode 224 may also be electrically connected to the control unit. For example, the control unit may be electrically connected to the upper first electrode 223a through an upper first electrode connection line L1. Further, the control unit may be electrically connected to the lower first electrode 223b through a lower first electrode connection line L2. Further, the control unit may be electrically connected to the second electrode 224 through a second electrode connection line L3.

Therefore, the control unit may control the heating performance and quality by applying power to at least any one of the upper first electrode 223a disposed on the upper heating element 220a and the lower first electrode 223b disposed on the lower heating element 220b in accordance with the situation. That is, the control unit may control the performance and quality in heating the vehicle interior by selectively applying power to the upper first electrode 223a and the lower first electrode 223b or cutting off the application of power to the upper first electrode 223a and the lower first electrode 223b. For example, the control unit may apply power to both the upper first electrode 223a and the lower first electrode 223b to perform the heating using both the radiant heat and the convective heat. In addition, the control unit may apply power only to the lower first electrode 223b when performing the heating using only the radiant heat.

The support member 300 may be disposed on a lower portion of the housing 100 and support the heating unit 200. In this case, the support member 300 may be formed in a container shape having one side and the other side that communicate with each other so that the air flowing along the housing 100 may be discharged. Therefore, the heating unit 200 may be disposed on the lower portion of the support member 300.

In addition, the support member 300 may be formed by injection molding a synthetic resin material such as plastic.

The cover 400 may prevent the heating unit 200 from coming into direct contact with a human body or an object. As illustrated in FIG. 5, the cover 400 may be disposed to cover one side of the heating unit 200.

The cover 400 may be disposed at a lower side of the heating unit 200 that is one side of the heating unit 200. The cover 400 may be coupled to the support member 300 and prevent the separation of the heating unit 200. For example, the cover 400 may be coupled to the support member 300 by using a hook coupled to a protrusion formed on a lateral surface of the support member 300.

As illustrated in FIG. 7, the cover 400 may be formed in a lattice shape.

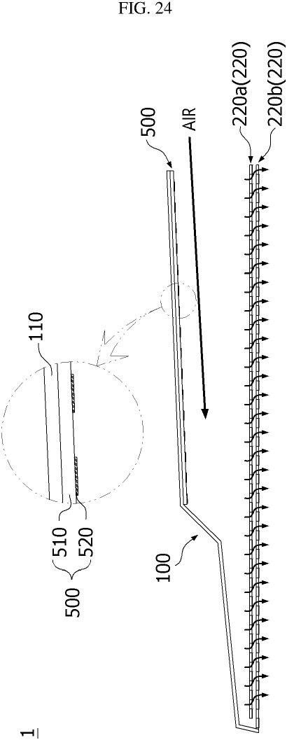

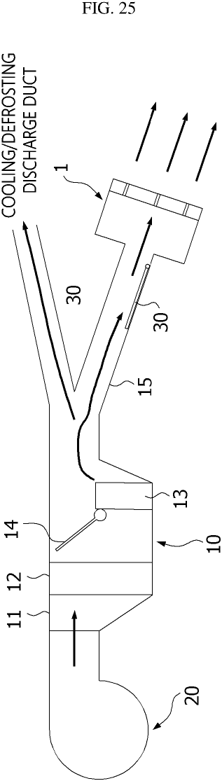

FIG. 24 is a view illustrating the vehicle heating device according to the embodiment that includes a heating part.

Referring to FIG. 24, the vehicle heating device 1 may further include a heating part 500.

The heating part 500 may be disposed on one surface of an inner portion of the duct part 110 and heat the air flowing along the interior of the duct part 110. Therefore, the heating part 500 may serve as an auxiliary heater and further lower a temperature of air heated by the heater 13, thereby further minimizing a thermal loss through the floor duct 15. Further, the use of the heating part 500 may reduce the size of the heater 13, which may also reduce the size of the air-conditioning unit 10 in which the heater 13 is disposed. Therefore, the heating part 500 of the vehicle heating device 1 may improve a degree of design freedom of the vehicle interior.

In addition, the heating part 500 may include a base 510 disposed on one surface of the inner portion of the duct part 110, and heat generating parts 520 disposed on the base. The heat generating part 520 may receive power through the electrode or the like, and the power may be controlled by the control unit. Therefore, the heating part 500 of the vehicle heating device 1 may improve the heating ability.

Meanwhile, the heating part 500 may be disposed on the duct part 110 by using a bonding member (not illustrated). Alternatively, the heating part 500 may be formed by forming the heat generating parts 520 and the electrodes electrically connected to the heat generating parts 520 on one surface of the inner portion of the duct part 110.

In addition, the heating part 500 may be electrically connected to the control unit and controlled by the control unit.

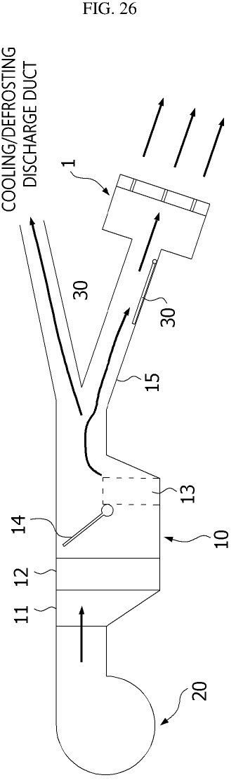

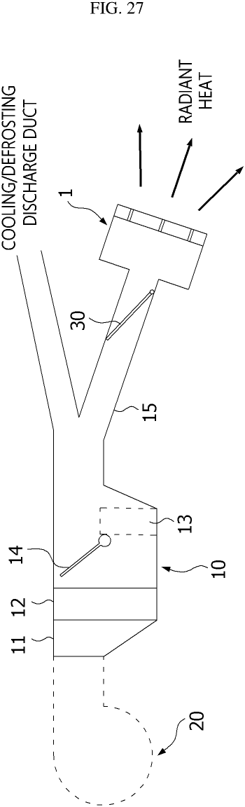

FIGS. 25 to 27 are views illustrating an operation of controlling an operation of the vehicle heating device according to the embodiment, in which FIG. 25 is a view illustrating a maximum heating mode of the vehicle heating device according to the embodiment, FIG. 26 is a view illustrating a mild heating mode of the vehicle heating device according to the embodiment, and FIG. 27 is a view illustrating a radiation mode of the vehicle heating device according to the embodiment.

Referring to FIG. 25, the heater 13 of the air-conditioning unit 10, the blower unit 20, and the heating unit 200 of the vehicle heating device 1 may be in an ON state and heat the air supplied by the blower unit 20. In this case, the door 30 disposed in the floor duct 15 is in an open state. In this case, the ON state may mean a state in which the respective components operate by receiving power. Further, the heater 13 of the air-conditioning unit 10, the blower unit 20, the door 30, and the heating unit 200 of the vehicle heating device 1 may be controlled by the control unit.

For example, the air supplied into the air-conditioning unit 10 by the blower unit 20 may be primarily heated by the heater 13, secondarily heated by the vehicle heating device 1, and then discharged to the interior of the vehicle. Therefore, the interior of the vehicle may be maximally heated in the maximum heating mode. The operation condition of the maximum heating mode may be a condition in which a temperature of outside air is 20 degrees below zero or a temperature of the vehicle interior reaches 15 degrees.

Referring to FIG. 26, the blower unit 20 and the heating unit 200 of the vehicle heating device 1 may be in an ON state and heat the air supplied by the blower unit 20. In this case, the heater 13 of the air-conditioning unit 10 is in an OFF state, and the door 30 disposed in the floor duct 15 is in an open state. In this case, the OFF state may mean a state in which the components do not operate as the application power to the components is cut off.

For example, the air may be supplied to the vehicle heating device 1 by the blower unit 20 through the interior of the air-conditioning unit 10 and the floor duct 15. Further, the air may be heated by the vehicle heating device 1 and discharged to the interior of the vehicle. Therefore, the interior of the vehicle may be heated in the mild heating mode. The operation condition of the mild heating mode may be a condition in which a temperature of outside air within a range of 5 to 10 degrees above zero or a temperature of the vehicle interior reaches 15 degrees after the maximum heating mode.

Referring to FIG. 27, the heating unit 200 of the vehicle heating device 1 may be in an ON state and perform the heating by using the radiant heat. In this case, the blower unit 20 and the heater 13 of the air-conditioning unit 10 are in an OFF state, and the door 30 disposed in the floor duct 15 is in a closed state.

For example, because the blower unit 20 does not operate and the door 30 is in the closed state, the supply of air to the vehicle heating device 1 may be cut off. Therefore, in the radiation heating mode, the interior of the vehicle may be heated only by the vehicle heating device 1. According to the operation condition of the radiation mode, the vehicle heating device 1 may be operated when the cold start is performed on the vehicle, when the vehicle is initially operated in an extremely low temperature of 20 degrees or lower below zero, when a temperature of the vehicle interior reaches a preset temperature, or when the occupant’s selection is made.

While the present invention has been described above with reference to exemplary embodiments, it may be understood by those skilled in the art that various modifications and changes of the present invention may be made within a range not departing from the spirit and scope of the present invention defined by the appended claims.

### Explanation of Reference Numerals and Symbols

1: Vehicle heating device, 10: Air-conditioning unit, 15: Floor duct, 20: Blower unit, 30: Door, 100: Housing, 110: Duct part, 120: Guide, 200: Heating unit, 210: Frame, 220: Heating element, 221: Body, 221a: Ventilation hole, 222: Heat generating part, 223: First electrode, 224: Second electrode, 230: Fixing member, 240: Detector, 300: Support member, 400: Cover, 500: Heating part

1. A vehicle heating device comprising:
a heating unit having one side connected to an air-conditioning casing and the other side disposed toward an occupant in an occupant compartment, the heating unit being configured to radiate heat,
wherein the heating unit heats an interior of the occupant compartment through at least any one of heat convection and heat radiation,
wherein the heat convection is formed in the occupant compartment by heating air supplied from the air-conditioning casing and passing through the heating unit, and
wherein the heat radiation heats the occupant by radiating heat directly toward the occupant.

2. The vehicle heating device of claim 1, wherein the heating unit comprises:
a frame; and
a planar upper heating element and a planar lower heating element disposed on the frame and spaced apart from each other to define a heat exchange region, and
wherein heat radiated from the upper heating element and heat radiated from the lower heating element exchange heat with air passing through the heating unit in the heat exchange region.

3. The vehicle heating device of claim 2, wherein the heat exchange region is provided in plural, and
wherein the plurality of heat exchange regions comprises:
a first heat exchange region formed at a front end of the upper heating element based on a flow direction of air; and
a second heat exchange region formed between the upper heating element and the lower heating element.

4. The vehicle heating device of claim 3, wherein the second heat exchange region is formed in the frame of the heating unit, and the upper heating element and the lower heating element are disposed outside the frame.

5. The vehicle heating device of claim 3, wherein air passing through ventilation holes of the upper heating element exchanges heat with radiant heat from the upper heating element and the lower heating element while being mixed with the radiant heat in the second heat exchange region before passing through ventilation holes of the lower heating element.

6. The vehicle heating device of claim 2, wherein the upper heating element and the lower heating element each comprise:
a planar body having a plurality of ventilation holes;
heat generating parts disposed on the body; and
first and second electrodes disposed on the body and configured to apply power to the heat generating parts.

7. The vehicle heating device of claim 6, wherein the heat generating parts of the lower heating element are disposed to overlap the ventilation holes of the upper heating element based on a flow direction of air.

8. The vehicle heating device of claim 6, wherein the ventilation hole of the lower heating element is disposed to overlap the ventilation hole of the upper heating element based on a flow direction of air.

9. The vehicle heating device of claim 7 , wherein the heat generating parts are disposed adjacent to the ventilation holes or disposed to be spaced apart from the ventilation holes with the electrodes interposed therebetween.

10. The vehicle heating device of claim 7, wherein the body of the upper heating element comprises:
a first surface disposed to face the lower heating element; and
a second surface opposite to the first surface, and
wherein the heat generating parts of the upper heating element are disposed on the second surface and face air supplied toward the heating unit.

11. The vehicle heating device of claim 1, wherein the heating unit comprises:
a frame;
a planar heating element disposed on the frame and configured to generate heat; and
a fixing member coupled to the frame and configured to fix the heating element to the frame,
wherein the heating element comprises:
a planar body having a plurality of ventilation holes;
heat generating parts mounted on the body; and
first and second electrodes disposed on the body and configured to apply power to the heat generating parts, and
wherein the body is bent to define an upper heating element and a lower heating element disposed to be spaced apart from each other.

12. The vehicle heating device of claim 11, wherein the first electrodes comprise:
an upper first electrode electrically connected to the upper heating element; and
a lower first electrode electrically connected to the lower heating element, and
wherein the control unit selectively applies power to the upper first electrode and the lower first electrode.

13. The vehicle heating device of claim 11, wherein the heating element comprises:
two active regions in which the heat generating parts are disposed; and
an inactive region disposed between the two active regions, and
wherein the inactive region is disposed to face one surface of the frame.

14. The vehicle heating device of claim 1, wherein the heating unit comprises:
a frame, a planar heating element disposed on the frame and configured to generate heat; and
a detector disposed to be in contact with the heating element,
wherein the heating element comprises:
a planar body having a plurality of ventilation holes;
heat generating parts mounted on the body; and
first and second electrodes disposed on the body and configured to apply power to the heat generating parts, and
wherein the application of power to the heat generating part is cut off when a line disposed on the detector is deformed.

15. The vehicle heating device of claim 1, further comprising:
a housing having one side connected to a floor duct of the air-conditioning casing and the other side having an opening,
wherein the heating unit is disposed in the opening, and the housing is rotatably disposed at an end of the floor duct.

16. The vehicle heating device of claim 1, further comprising:
a housing having one side connected to a floor duct of the air-conditioning casing and the other side having an opening,
wherein the housing comprises:
a duct part connected to the floor duct and configured to communicate with the floor duct; and
a guide disposed in the opening, and
wherein the guide guides air, which is discharged through a plurality of holes, to the heating unit.

17. The vehicle heating device of claim 16, wherein the guide comprises:
a body having a plurality of holes; and
a guide protrusion protruding from the body,
wherein the plurality of holes comprises first and second holes having different sizes,
wherein the second hole is disposed to be closer to the air-conditioning casing than is the first hole, and
wherein the guide protrusion guides air discharged through the first hole.

18. The vehicle heating device of claim 16, wherein the housing further comprises a heating part disposed on one surface of an inner portion of the duct part, and the heating part heats air flowing along an interior of the duct part.

19. A heating unit comprising:
a frame; and
a planar upper heating element and a planar lower heating element disposed on the frame and spaced apart from each other to define a heat exchange region,
wherein the upper heating element and the lower heating element each comprise:
a planar body having a plurality of ventilation holes;
heat generating parts mounted on the body; and
first and second electrodes disposed on the body and configured to apply power to the heat generating parts, and
wherein heat radiated from the upper heating element and heat radiated from the lower heating element exchange heat with air passing through the heat exchange region in the heat exchange region.

20. The heating unit of claim 19, wherein the heat generating parts of the lower heating element are disposed to overlap the ventilation holes of the upper heating element based on a flow direction of air.
